(19) United States
(12) Patent Application Publication
(10) Pub. No.: US 2025/0106897 A1
(43) Pub. Date: Mar. 27, 2025

(54) METHODS AND APPARATUSES FOR DEACTIVATION SN WITH MULTIPLE TRPS AND SCG ACTIVATION FAILURE

(71) Applicant: LENOVO (BEIJING) LIMITED, Beijing (CN)

(72) Inventors: Lianhai WU, Beijing (CN); Congchi ZHANG, Shanghai (CN); Mingzeng DAI, Shanghai (CN); Le YAN, Shanghai (CN)

(21) Appl. No.: 18/725,413

(22) PCT Filed: Mar. 4, 2022
(86) PCT No.: PCT/CN2022/079407

§ 371 Date: Jun. 28, 2024

(51) Int. Cl. H04W 74/0833; H04W 76/19; H04W 76/20

(52) U.S. Cl. CPC H04W 74/0833; H04W 76/19; H04W 76/20

(57) ABSTRACT

Embodiments of the present application relate to methods and apparatuses for deactivation secondary node (SN) with multiple transmission reception points (TRPs) and a secondary cell group (SCG) activation failure. According to an embodiment of the present application, a user equipment (UE) includes a transceiver and a processor coupled to the transceiver; and the processor is configured: to receive a first configuration associated with a set of transmission reception points (TRPs) for a secondary cell group (SCG) of a network; to receive a second configuration associated with a state of the SCG of the network, wherein the state of the SCG corresponds to a deactivated state; to receive an activation indication associated with the SCG from the network; and to access to the SCG via a random access channel (RACH) procedure.

### TECHNICAL FIELD

Embodiments of the present application generally relate to wireless communication technology, especially to methods and apparatuses for deactivation secondary node (SN) with multiple transmission reception points (TRPs) and a secondary cell group (SCG) activation failure.

### BACKGROUND

Currently, 3rd Generation Partnership Project (3GPP) RAN2 has agreed the common understanding for a scenario which refers to an inter-cell multi-TRP-like model. In particular, in this scenario, a UE receives, from a serving cell, configuration(s) of synchronization signal block(s) (SSB(s)) of a TRP with a different physical layer identifier (PCID) for a beam measurement and configuration(s) needed to use radio resources for data transmission or data reception including resources for the different PCID. The UE performs a beam measurement for the TRP with the different PCID and reports a measurement result to the serving cell. Based on the above reports, transmission configuration indicator (TCI) state(s) associated with the TRP with the different PCID is activated from the serving cell (by L1/L2 signaling). A TCI may be a SSB or a channel state information reference signal (CSI-RS). The UE receives and transmits using a UE-dedicated channel on the TRP with the different PCID. The UE should be in coverage of a serving cell always, also for a multi-TRP case, e.g., the UE should use common channels broadcast control channel (BCCH), paging control channel (PCCH), and etc., from the serving cell.

Next generation radio access network (NG-RAN) supports a multi-radio dual connectivity (MR-DC) operation. In the MR-DC operation, a user equipment (UE) with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3GPP standard documents), and at least the MN is connected to the core network.

However, several issues related to a scenario which refers to an inter-cell multi-TRP-like model with a MR-DC operation have not been discussed in 3GPP 5G technology yet and the corresponding solutions have not been specified.

### SUMMARY

Some embodiments of the present application also provide a UE. The UE includes a transceiver and a processor coupled to the transceiver; and the processor is configured: to receive a first configuration associated with a set of transmission reception points (TRPs) for a secondary cell group (SCG) of a network; to receive a second configuration associated with a state of the SCG of the network, wherein the state of the SCG corresponds to a deactivated state; to receive an activation indication associated with the SCG from the network; and to access to the SCG via a random access channel (RACH) procedure.

In some embodiments, to access to the SCG, the processor of the UE is configured to access to the SCG via the RACH procedure in response to at least one of: an expiry of a time alignment timer (TAT), declaring a radio link failure (RLF) associated with the SCG, or detecting a beam failure associated with the SCG.

In some embodiments, the processor of the UE is configured: to receive an indication indicating the UE not to perform a radio link monitoring (RLM) operation on the SCG while the state of the SCG corresponds to the deactivated state; and in response to receiving the indication, to perform at least one of: stopping a physical layer problem timer; stopping a timer for initiating failure recovery based on triggering a measurement report; resetting a counter for consecutive out-of-synchronization indication; or resetting a counter for consecutive in-synchronization indication.

In some embodiments, the processor of the UE is configured: to perform a beam failure detection operation while the state of the SCG corresponds to the deactivated state; and in response to detecting a beam failure on one or more TRPs within the set of TRPs, to transmit first information to the network via a radio resource control (RRC) message, wherein the first information includes at least one of: index information of the one or more TRPs; a beam failure detection (BFD) reference signal (RS) set identity (ID) of the one or more TRPs; a cell index for a primary cell of a second cell group (PSCell) of the SCG; a cell index for a secondary cell (SCell) of the SCG; a candidate RS ID for a failed TRP within the one or more TRPs; or an indication indicating whether one or more candidate beams for the one or more TRPs are found.

In some embodiments, the processor of the UE is configured: to perform a beam failure detection operation while the state of the SCG corresponds to the deactivated state; and in response to detecting a beam failure on a primary cell of a second cell group (PSCell) of the SCG, to transmit second information to the network via a radio resource control (RRC) message, wherein the second information includes at least one of: a cell index for a primary cell of the PSCell; a cell index for a secondary cell (SCell) of the SCG; a candidate RS ID for a failed TRP within the PSCell; an indication indicating whether one or more candidate beams for a TRP are found; index information of a firstly failed TRP in two or more TRPs within the PSCell, in response to detecting beam failures on the two or more TRPs; a BFD RS set ID of the firstly failed TRP, in response to detecting the beam failures on the two or more TRPs; or a time gap between BFD operations of two TRPs within the PSCell, in response to detecting beam failures on the two TRPs.

In some embodiments, the network is a master cell group (MCG), and wherein, in response to transmitting the first information or the second information, the first information or the second information is transferred by the MCG to the SCG.

In some embodiments, the RRC message is a SCG failure information message.

In some embodiments, to access to the SCG, the processor of the UE is configured to perform the RACH procedure using a random access (RA) resource set for beam failure recovery (BFR), in response to: receiving the activation indication associated with the SCG and detecting a beam failure associated with the SCG.

In some embodiments, to access to the SCG, the processor of the UE is configured to perform the RACH procedure using a random access (RA) resource set for beam failure recovery (BFR), in response to detecting a beam failure associated with the SCG and in response to at least one of a TAT not being running and declaring a RLF associated with the SCG.

In some embodiments, the processor of the UE is configured to receive a message including both a RA resource set and the activation indication associated with the SCG, and wherein, to access to the SCG, the processor of the UE is configured to access to the SCG via the RACH procedure using the RA resource set in the message.

In some embodiments, the processor of the UE is configured to receive an indication indicating which RA resource set can be used for the RACH procedure, and wherein, to access to the SCG, the processor of the UE is configured to access to the SCG via the RACH procedure using a RA resource set indicated by the indication.

In some embodiments, the processor of the UE is configured: to initiate a SCG failure information procedure, in response to failing to access the SCG or in response to detecting a SCG activation failure associated with the SCG; and to transmit a message including a failure type to the network.

In some embodiments, the failure type is set as at least one of: a SCG activation failure; a RLF; a beam failure recovery failure, in response to initiating the RACH procedure for beam failure recovery (BFR) or in response to using a random access (RA) resource set for BFR for activating the SCG; a SCG synchronization reconfiguration failure; or a type related to a firstly occurred failure within two or more failures, in response to detecting the two or more failures during activating the SCG.

In some embodiments, the processor of the UE is configured: to receive a third configuration associated with a condition from the network; and to transmit a request to deactivate the SCG to the network, in response to the condition being fulfilled. In some embodiments, the condition is that no uplink (UL) data is transmitted to the SCG during a time duration. In some embodiments, the network comprises a MCG, and wherein the request to deactivate the SCG is transferred by the MCG to the SCG.

In some embodiments, at least one of the first configuration, the second configuration, or the third configuration is received via at least one of: a radio resource control (RRC) message; or a medium access control (MAC) control element (CE).

In some embodiments, the network comprises a MCG, and wherein at least one of the first configuration, the second configuration, or the third configuration are received by the MCG from the SCG and then transmitted by the MCG to the UE.

Some embodiments of the present application provide a method performed by a UE. The method includes: receiving a first configuration associated with a set of transmission reception points (TRPs) for a secondary cell group (SCG) from a network; receiving a second configuration associated with a state of the SCG from the network, wherein the state of the SCG corresponds to a deactivated state; receiving an activation indication associated with the SCG from the network; and accessing to the SCG via a random access channel (RACH) procedure.

In some embodiments, accessing to the SCG further comprises accessing to the SCG via the RACH procedure in response to at least one of: an expiry of a time alignment timer (TAT), declaring a radio link failure (RLF) associated with the SCG, or detecting a beam failure associated with the SCG.

In some embodiments, the method further comprises: receiving an indication indicating the UE not to perform a radio link monitoring (RLM) operation on the SCG while the state of the SCG corresponds to the deactivated state; and in response to receiving the indication, performing at least one of: stopping a physical layer problem timer; stopping a timer for initiating failure recovery based on triggering a measurement report; resetting a counter for consecutive out-of-synchronization indication; or resetting a counter for consecutive in-synchronization indication.

In some embodiments, the method further comprises: performing a beam failure detection operation while the state of the SCG corresponds to the deactivated state; and in response to detecting a beam failure on one or more TRPs within the set of TRPs, transmitting first information to the network via a radio resource control (RRC) message, wherein the first information includes at least one of: index information of the one or more TRPs; a beam failure detection (BFD) reference signal (RS) set identity (ID) of the one or more TRPs; a cell index for a primary cell of a second cell group (PSCell) of the SCG; a cell index for a secondary cell (SCell) of the SCG; a candidate RS ID for a failed TRP within the one or more TRPs; or an indication indicating whether one or more candidate beams for the one or more TRPs are found.

In some embodiments, the method further comprises: performing a beam failure detection operation while the state of the SCG corresponds to the deactivated state; and in response to detecting a beam failure on a primary cell of a second cell group (PSCell) of the SCG, transmitting second information to the network via a radio resource control (RRC) message, wherein the second information includes at least one of: a cell index for a primary cell of the PSCell; a cell index for a secondary cell (SCell) of the SCG; a candidate RS ID for a failed TRP within the PSCell; an indication indicating whether one or more candidate beams for a TRP are found; index information of a firstly failed TRP in two or more TRPs within the PSCell, in response to detecting beam failures on the two or more TRPs; a BFD RS set ID of the firstly failed TRP, in response to detecting the beam failures on the two or more TRPs; or a time gap between BFD operations of two TRPs within the PSCell, in response to detecting beam failures on the two TRPs.

In some embodiments, the network is a master cell group (MCG), and wherein, in response to transmitting the first information or the second information, the first information or the second information is transferred by the MCG to the SCG.

In some embodiments, the RRC message is a SCG failure information message.

In some embodiments, accessing to the SCG further comprises: performing the RACH procedure using a random access (RA) resource set for beam failure recovery (BFR), in response to: receiving the activation indication associated with the SCG and detecting a beam failure associated with the SCG.

In some embodiments, accessing to the SCG further comprises: performing the RACH procedure using a random access (RA) resource set for beam failure recovery (BFR), in response to detecting a beam failure associated with the SCG and in response to at least one of a TAT not being running and declaring a RLF associated with the SCG.

In some embodiments, the method further comprises: receiving a message including both a RA resource set and the activation indication associated with the SCG, wherein accessing to the SCG further comprising accessing to the SCG via the RACH procedure using the RA resource set in the message.

In some embodiments, the method further comprises: receiving an indication indicating which RA resource set can be used for the RACH procedure, wherein accessing to the SCG further comprising accessing to the SCG via the RACH procedure using a RA resource set indicated by the indication.

In some embodiments, the method further comprises: initiating a SCG failure information procedure, in response to failing to access the SCG or in response to detecting a SCG activation failure associated with the SCG; and transmitting a message including a failure type to the network.

In some embodiments, the failure type is set as at least one of: a SCG activation failure; a RLF; a beam failure recovery failure, in response to initiating the RACH procedure for beam failure recovery (BFR) or in response to using a random access (RA) resource set for BFR for activating the SCG; a SCG synchronization reconfiguration failure; or a type related to a firstly occurred failure within two or more failures, in response to detecting the two or more failures during activating the SCG.

In some embodiments, the method further comprises: receiving a third configuration associated with a condition from the network; and transmitting a request to deactivate the SCG to the network, in response to the condition being fulfilled. In some embodiments, the condition is that no uplink (UL) data is transmitted to the SCG during a time duration. In some embodiments, the network comprises a MCG, and wherein the request to deactivate the SCG is transferred by the MCG to the SCG.

In some embodiments, at least one of the first configuration, the second configuration, or the third configuration are received via at least one of: a radio resource control (RRC) message; or a medium access control (MAC) control element (CE).

In some embodiments, the network comprises a MCG, and wherein at least one of the first configuration, the second configuration, or the third configuration are received by the MCG from the SCG and then transmitted by the MCG to the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application also provide a network (e.g., a master node (MN)). The network node includes a transceiver and a processor coupled to the transceiver; and the processor is configured: to transmit a first configuration associated with a set of transmission reception points (TRPs) for a secondary cell group (SCG) to a user equipment (UE); to transmit a second configuration associated with a state of the SCG to the UE, wherein the state of the SCG corresponds to a deactivated state; to transmit an activation indication associated with the SCG to the UE; and to receive first information from the UE via a radio resource control (RRC) message, wherein the first information is associated with a beam failure associated with the SCG.

In some embodiments, in response to detecting a beam failure on one or more TRPs within the set of TRPs, the first information includes at least one of: index information of the one or more TRPs; a beam failure detection (BFD) reference signal (RS) set identity (ID) of the one or more TRPs; a cell index for a primary cell of a second cell group (PSCell) of the SCG; a cell index for a secondary cell (SCell) of the SCG; a candidate RS ID for a failed TRP within the one or more TRPs; or information indicating whether one or more candidate beams for the one or more TRPs are found.

In some embodiments, in response to detecting a beam failure on a primary cell of a second cell group (PSCell) of the SCG, the first information includes at least one of: a cell index for a primary cell of the PSCell; a cell index for a secondary cell (SCell) of the SCG; a candidate RS ID for a failed TRP within the PSCell; an indication indicating whether one or more candidate beams for a TRP are found; index information of a firstly failed TRP in two or more TRPs within the PSCell, in response to detecting beam failures on the two or more TRPs; a BFD RS set ID of the firstly failed TRP, in response to detecting the beam failures on the two or more TRPs; or a time gap between BFD operations of two TRPs within the PSCell, in response to detecting beam failures on the two TRPs.

In some embodiments, the RRC message is a SCG failure information message.

In some embodiments, the processor of the MN is configured to transmit the first information to the SCG.

In some embodiments, the processor of the MN is configured to transmit an indication indicating the UE not to perform a radio link monitoring (RLM) operation on the SCG while the state of the SCG corresponds to the deactivated state to the UE.

In some embodiments, the processor of the MN is configured to transmit a message including both a RA resource set and the activation indication associated with the SCG to the UE, and wherein the RA resource set in the message is used by the UE to access to the SCG via a random access channel (RACH) procedure.

In some embodiments, the processor of the MN is configured to transmit an indication indicating which random access (RA) resource set can be used for the RACH procedure to the UE, wherein a RA resource set indicated by the indication is used by the UE to access to the SCG via a random access channel (RACH) procedure.

In some embodiments, the processor of the MN is configured to receive a message including a failure type from the UE, in response to the UE failing to access the SCG or in response to the UE detecting a SCG activation failure associated with the SCG.

In some embodiments, the failure type is set as at least one of: a SCG activation failure; a RLF; or a beam failure recovery failure, in response to initiating the RACH procedure for beam failure recovery (BFR) or in response to using a random access (RA) resource set for BFR for activating the SCG; or a SCG synchronization reconfiguration failure; or a type related to a firstly occurred failure within two or more failures, in response to detecting the two or more failures during activating the SCG.

In some embodiments, the processor of the MN is configured: to transmit a third configuration associated with a condition to the UE; and to receive a request to deactivate the SCG from the UE, in response to the condition being fulfilled.

In some embodiments, the condition is that no uplink (UL) data is transmitted to the SCG during a time duration.

In some embodiments, the processor of the MN is configured to transmit the request to deactivate the SCG to the SCG.

In some embodiments, at least one of the first configuration, the second configuration, or the third configuration are transmitted via at least one of: a radio resource control (RRC) message; or a medium access control (MAC) control element (CE).

In some embodiments, at least one of the first configuration, the second configuration, or the third configuration are received by the MCG from the SCG and then transmitted by the MCG to the UE.

Some embodiments of the present application provide a method performed by a network (e.g., a MN). The method includes: transmitting a first configuration associated with a set of transmission reception points (TRPs) for a secondary cell group (SCG) to a user equipment (UE); transmitting a second configuration associated with a state of the SCG to the UE, wherein the state of the SCG corresponds to a deactivated state; transmitting an activation indication associated with the SCG to the UE; and receiving first information from the UE via a radio resource control (RRC) message, wherein the first information is associated with a beam failure associated with the SCG.

In some embodiments, in response to detecting a beam failure on one or more TRPs within the set of TRPs, the first information includes at least one of: index information of the one or more TRPs; a beam failure detection (BFD) reference signal (RS) set identity (ID) of the one or more TRPs; a cell index for a primary cell of a second cell group (PSCell) of the SCG; a cell index for a secondary cell (SCell) of the SCG; a candidate RS ID for a failed TRP within the one or more TRPs; or information indicating whether one or more candidate beams for the one or more TRPs are found.

In some embodiments, in response to detecting a beam failure on a primary cell of a second cell group (PSCell) of the SCG, the first information includes at least one of: a cell index for a primary cell of the PSCell; a cell index for a secondary cell (SCell) of the SCG; a candidate RS ID for a failed TRP within the PSCell; an indication indicating whether one or more candidate beams for a TRP are found; index information of a firstly failed TRP in two or more TRPs within the PSCell, in response to detecting beam failures on the two or more TRPs; a BFD RS set ID of the firstly failed TRP, in response to detecting the beam failures on the two or more TRPs; or a time gap between BFD operations of two TRPs within the PSCell, in response to detecting beam failures on the two TRPs.

In some embodiments, the RRC message is a SCG failure information message.

In some embodiments, the method further comprises: transmitting the first information to the SCG.

In some embodiments, the method further comprises: transmitting an indication indicating the UE not to perform a radio link monitoring (RLM) operation on the SCG while the state of the SCG corresponds to the deactivated state to the UE.

In some embodiments, the method further comprises: transmitting a message including both a RA resource set and the activation indication associated with the SCG to the UE, wherein the RA resource set in the message is used by the UE to access to the SCG via a random access channel (RACH) procedure.

In some embodiments, the method further comprises: transmitting an indication indicating which random access (RA) resource set can be used for the RACH procedure to the UE, wherein a RA resource set indicated by the indication is used by the UE to access to the SCG via a random access channel (RACH) procedure.

In some embodiments, the method further comprises: in response to the UE failing to access the SCG or in response to the UE detecting a SCG activation failure associated with the SCG, receiving a message including a failure type from the UE.

In some embodiments, the failure type is set as at least one of: a SCG activation failure; a RLF; or a beam failure recovery failure, in response to initiating the RACH procedure for beam failure recovery (BFR) or in response to using a random access (RA) resource set for BFR for activating the SCG; or a SCG synchronization reconfiguration failure; or a type related to a firstly occurred failure within two or more failures, in response to detecting the two or more failures during activating the SCG.

In some embodiments, the method further comprises: transmitting a third configuration associated with a condition to the UE; and receiving a request to deactivate the SCG from the UE, in response to the condition being fulfilled.

In some embodiments, the condition is that no uplink (UL) data is transmitted to the SCG during a time duration.

In some embodiments, the method further comprises: transmitting the request to deactivate the SCG to the SCG.

In some embodiments, at least one of the first configuration, the second configuration, or the third configuration are transmitted via at least one of: a radio resource control (RRC) message; or a medium access control (MAC) control element (CE).

In some embodiments, at least one of the first configuration, the second configuration, or the third configuration are received by the MCG from the SCG and then transmitted by the MCG to the UE.

Some embodiments of the present application also provide a network (e.g., a secondary node (SN)). The network includes a transceiver and a processor coupled to the transceiver; and the processor is configured to receive first information from a master cell group (MCG) via a radio resource control (RRC) message, wherein the first information is associated with a beam failure associated with a secondary cell group (SCG), wherein a state of the SCG corresponds to a deactivated state, and wherein the first information is received by the MCG from a user equipment (UE).

In some embodiments, in response to detecting a beam failure on one or more TRPs within the set of TRPs, the first information includes at least one of: index information of the one or more TRPs; a beam failure detection (BFD) reference signal (RS) set identity (ID) of the one or more TRPs; a cell index for a primary cell of a second cell group (PSCell) of the SCG; a cell index for a secondary cell (SCell) of the SCG; a candidate RS ID for a failed TRP within the one or more TRPs; or information indicating whether one or more candidate beams for the one or more TRPs are found.

In some embodiments, in response to detecting a beam failure on a primary cell of a second cell group (PSCell) of the SCG, the first information includes at least one of: a cell index for a primary cell of the PSCell; a cell index for a secondary cell (SCell) of the SCG; a candidate RS ID for a failed TRP within the PSCell; an indication indicating whether one or more candidate beams for a TRP are found; index information of a firstly failed TRP in two or more TRPs within the PSCell, in response to detecting beam failures on the two or more TRPs; a BFD RS set ID of the firstly failed TRP, in response to detecting the beam failures on the two or more TRPs; or a time gap between BFD operations of two TRPs within the PSCell, in response to detecting beam failures on the two TRPs.

In some embodiments, the RRC message is a SCG failure information message.

In some embodiments, the processor of the SN is configured to transmit a first configuration associated with a set of TRPs for the SCG to the MCG.

In some embodiments, the processor of the SN is configured to transmit a second configuration associated with the SCG to the MCG.

In some embodiments, at least one of the first configuration or the second configuration are transmitted via at least one of: a radio resource control (RRC) message; or a medium access control (MAC) control element (CE).

In some embodiments, at least one of the first configuration or the second configuration are transferred by the MCG to the UE.

Some embodiments of the present application provide a method performed by a network (e.g., a SN). The method includes: receiving first information from a master cell group (MCG) via a radio resource control (RRC) message, wherein the first information is associated with a beam failure associated with a secondary cell group (SCG), wherein a state of the SCG corresponds to a deactivated state, and wherein the first information is received by the MCG from a user equipment (UE).

In some embodiments, in response to detecting a beam failure on one or more TRPs within the set of TRPs, the first information includes at least one of: index information of the one or more TRPs; a beam failure detection (BFD) reference signal (RS) set identity (ID) of the one or more TRPs; a cell index for a primary cell of a second cell group (PSCell) of the SCG; a cell index for a secondary cell (SCell) of the SCG; a candidate RS ID for a failed TRP within the one or more TRPs; or information indicating whether one or more candidate beams for the one or more TRPs are found.

In some embodiments, in response to detecting a beam failure on a primary cell of a second cell group (PSCell) of the SCG, the first information includes at least one of: a cell index for a primary cell of the PSCell; a cell index for a secondary cell (SCell) of the SCG; a candidate RS ID for a failed TRP within the PSCell; an indication indicating whether one or more candidate beams for a TRP are found; index information of a firstly failed TRP in two or more TRPs within the PSCell, in response to detecting beam failures on the two or more TRPs; a BFD RS set ID of the firstly failed TRP, in response to detecting the beam failures on the two or more TRPs; or a time gap between BFD operations of two TRPs within the PSCell, in response to detecting beam failures on the two TRPs.

In some embodiments, the RRC message is a SCG failure information message.

In some embodiments, the method further comprises: transmitting a first configuration associated with a set of TRPs for the SCG to the MCG.

In some embodiments, the method further comprises: transmitting a second configuration associated with the SCG to the MCG.

In some embodiments, at least one of the first configuration or the second configuration are transmitted via at least one of: a radio resource control (RRC) message; or a medium access control (MAC) control element (CE).

In some embodiments, at least one of the first configuration or the second configuration are transferred by the MCG to the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network (e.g., a MN or a SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system configured a MR-DC operation in accordance with some embodiments of the present application.

FIG. 2 illustrates scenarios on an inter-cell operation in accordance with some embodiments of the present application.

FIG. 3 illustrates an exemplary flowchart of reporting beam failure information in accordance with some embodiments of the present application.

FIG. 4 illustrates an exemplary flowchart of performing a RACH procedure in accordance with some embodiments of the present application.

FIG. 5 illustrates an exemplary flowchart of a SCG failure information procedure in accordance with some embodiments of the present application.

FIG. 6 illustrates an exemplary block diagram of an apparatus for a MR-DC case according to some embodiments of the present application.

FIG. 7 illustrates a further exemplary block diagram of an apparatus for a MR-DC case according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

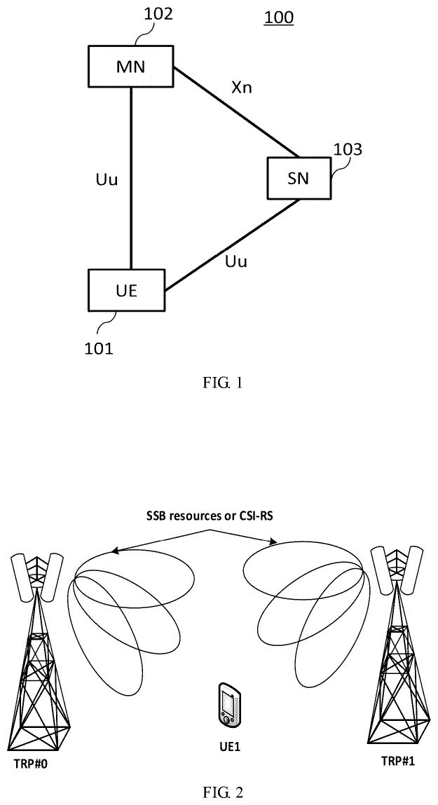

FIG. 1 illustrates a schematic diagram of a wireless communication system configured a MR-DC operation in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB. MN 102 may be associated with a MCG. The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB. SN 103 may be associated with a SCG. The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

FIG. 2 illustrates scenarios on an inter-cell operation in accordance with some embodiments of the present application.

In some cases, UE1 may receive, from a serving cell, configuration(s) of SSB(s) or a CSI-RS of a TRP (e.g., TRP #0 and/or TRP #1) with a PCID for a beam measurement and resource configuration(s) for data transmission or data reception associated with the PCID. UE1 performs a beam measurement for the TRP with the PCID and reports a measurement result to the serving cell. Based on the above reports, TCI state(s) associated with the TRP with the PCID is activated from the serving cell (by L1 signaling or L2 signaling). A TCI may be a SSB or a CSI-RS. UE1 receives and transmits using a UE-dedicated channel on the TRP with the PCID. UE1 should be in coverage of a serving cell always, also for a multi-TRP case, e.g., UE1 should use BCCH, PCCH, etc., from the serving cell. As shown in FIG. 2, UE1 is served by TRP #0 and TRP #1. UE1 can receive data from TRP #0 and TRP #1 at the same time.

In some embodiments of the present application, UE1 as shown in FIG. 2 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, networks (e.g., TRPs, routers, switches, and modems), or the like. In some other embodiments of the present application, UE1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE1 may include wearable devices, such as smart watches, fitness bands, optical head-mounted displays, or the like. Moreover, UE1 may be referred to as a subscriber unit, a mobile, a mobile station, a user, a terminal, a mobile terminal, a wireless terminal, a fixed terminal, a subscriber station, a user terminal, or a device, or described using other terminology used in the art.

Currently, more details regarding a UE's behavior and a MN's or a SN's behavior in a scenario which refers to an inter-cell multi-TRP-like model are unclear, several common issues have not been solved, and different solutions are needed in the different cases. Some embodiments of the subject application aim to provide solutions for a case of multi TRPs (mTRP) in one cell in a scenario which refers to an inter-cell multi-TRP-like model in which a MR-DC operation is configured. Some embodiments of the subject application study a UE's behaviors in the case that the UE indicates a beam failure (BF) to a network via a RRC message upon a BF while the SCG is deactivated. The additional information related with TRP is introduced to be reported to MCG in the case of mTRP. In some embodiments, if a BF of one TRP in deactivated SCG is detected in the case of two or more TRPs configured for one cell, a UE is expected to report the information to a SN via MCG.

Some embodiments of the subject application introduce a mechanism of selecting a RA resource set when a UE receives a SCG activation command in the case that a BF, a radio link failure (RLF) or a time alignment timer (TAT) expiry may happen.

In some embodiments of the subject application, if a UE fails to access to a SCG after the UE receives a SCG activation indication, a SCG failure information procedure may be triggered. A new failure type and a new failure type selection mechanism are introduced for a SCG failure information message.

More details regarding embodiments of the present application will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

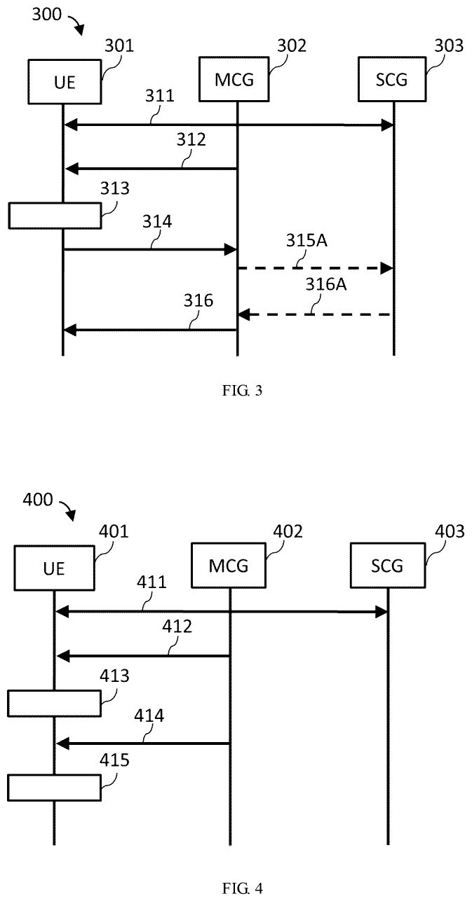

FIG. 3 illustrates an exemplary flowchart of reporting beam failure information in accordance with some embodiments of the present application. Details described in all other embodiments of the present disclosure are applicable for the embodiments shown in FIG. 3.

Exemplary procedure 300 refers to a case of multi TRPs (mTRP) in one cell in a scenario which refers to an inter-cell multi-TRP-like model in which a MR-DC operation is configured. Referring to FIG. 3, UE 301 may function as UE 101 as shown in FIG. 1. MCG 302 and SCG 303 may correspond to MN 103 and SN 103 as shown in FIG. 1, respectively. In particular, there may be following two specific embodiments in different cases in exemplary procedure 300, i.e., Embodiments 1 and 2.

In Embodiment 1, exemplary procedure 300 includes following steps.

In Step 311, UE 301 accesses a BS. MCG 302 and SCG 303 are configured to UE 301.
(1) For instance, measurement configuration(s) may be configured to UE 301 via MCG 302 or SCG 303.
(2) Configuration for a TRP (e.g., TRP #1) may be configured to UE 301 by MCG 302 or by SCG 303 via MCG 302.
(3) A BFD Set for a further TRP (e.g., TRP #2) may be configured to UE 301 by MCG 302 or by SCG 303 via MCG 302. BFD Set for the further TRP includes BFD resource set for UE 301 for mTRP BFD operation. The further TRP can be described as a BFD-RS set. For instance, the number of a BFD-RS set is the number of the corresponding TRP, e.g., TRP #2 is BFD-RS set #2.
(4) For example, one or more other TRPs (e.g., TRP #3 and etc.) may be configured to UE 301 by MCG 302 or by SCG 303 via MCG 302. Likewise, each of the one or more other TRPs can be described as a BFD-RS set. For example, TRP #3 is BFD-RS set #3.

In Step 312, UE 301 receives, from MCG 302, a RRC reconfiguration message indicating to deactivate SCG 303. In an embodiment, the RRCReconfiguration includes a SCG-State information element (IE). The SCG-State IE is set to a deactivated state. In an embodiment, MCG 302 configures UE 301 to perform a BFD operation while SCG 303 is in a deactivated state. In an embodiment, MCG 302 configures UE 301 to perform a RLM operation while SCG 303 is in a deactivated state.

In Step 313, in the case that MCG 302 configures UE 301 to perform a BFD operation, UE 301 performs the BFD operation for each TRP associated with SCG 303 (e.g., each TRP in a PSCell or a SCell of SCG 303) while SCG 303 is deactivated.

In Step 314, if UE 301 detects beam failure(s) for all configured TRPs associated with SCG 303, UE 301 is triggered to report beam failure information to MCG 302 (or SCG 303).
(1) For example, if two TRPs in total are configured in the PSCell of SCG 303, UE 301 may detect beam failures for all these two TRPs in the PSCell of SCG 303. Once UE 301 detects beam failures for all these two TRPs in the PSCell, UE 301 is triggered to report beam failure information to MCG 302 (or SCG 303).
(2) In an embodiment, the reported beam failure information may include at least one of:
   1) A cell index for a primary cell of the PSCell.
   2) A cell index for a secondary cell (SCell) of the SCG.
   3) A candidate RS ID for a failed TRP within the PSCell. Candidate RS ID may be transmitted in a field in a BFR MAC CE. This field may be set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidateBeamRSSCellList. The length of this field “Candidate RS ID” in a BFR MAC CE may be 6 bits.
   4) An indication indicating whether one or more candidate beams for a TRP are found.
   5) Index information of a firstly failed TRP in two or more TRPs within the PSCell, in response to detecting beam failures on the two or more TRPs.
   6) A BFD RS set ID of the firstly failed TRP, in response to detecting the beam failures on the two or more TRPs.
   7) A time gap between BFD operations of two TRPs within the PSCell, in response to detecting beam failures on the two TRPs.

After Step 314, there may be following two options in different embodiments, i.e., Option 1 and Option 2.
(1) In Option 1, only Step 316 is performed after Step 314. In Step 316, after MCG 302 receives the beam failure information, MCG 302 may reconfigure a beam or a TRP to UE 301. MCG 302 transmits “configurations for reconfiguring a beam or a TRP associated with SCG 303” to UE 301.
(2) In Option 2, Steps 315A, 316A, and 316 are performed after Step 314.
   1) In Step 315A, after MCG 302 receives the beam failure information from UE 301, MCG 302 transfers the beam failure information to SCG 303.
   2) In Step 316A, SCG 303 transmits “configurations for reconfiguring a beam or a TRP associated with SCG 303” to MCG 302, and then MCG 302 transfers the reconfigure information to UE 301.
   3) In Step 316, after MCG 302 receives the beam failure information, MCG 302 may reconfigure a beam or a TRP to UE 301. MCG 302 transmits “configurations for reconfiguring a beam or a TRP associated with SCG 303” to UE 301.

In Embodiment 2, exemplary procedure 300 includes following steps.

In Step 311, UE 301 accesses a BS. MCG 302 and SCG 303 are configured to UE 301.
(1) For instance, measurement configuration(s) may be configured to UE 301 via MCG 302 or SCG 303. Configuration for a TRP (e.g., TRP #1) may be configured to UE 301 by MCG 302 or by SCG 303 via MCG 302.
(2) A BFD Set for a further TRP (e.g., TRP #2) may be configured to UE 301 by MCG 302 or by SCG 303 via MCG 302. BFD Set for the further TRP includes BFD resource set for UE 301 for mTRP BFD operation. The further TRP can be described as a BFD-RS set. For instance, the number of a BFD-RS set is the number of the corresponding TRP, e.g., TRP #2 is BFD-RS set #2.
(3) For example, one or more other TRPs (e.g., TRP #3 and etc.) may be configured to UE 301 by MCG 302 or by SCG 303 via MCG 302. Likewise, each of the one or more other TRPs can be described as a BFD-RS set. For example, TRP #3 is BFD-RS set #3.

In Step 312, UE 301 receives, from MCG 302, a RRC reconfiguration message indicating to deactivate SCG 303. In an embodiment, the RRCReconfiguration includes a SCG-State information element (IE). The SCG-State IE is set to a deactivated state. In an embodiment, MCG 302 configures UE 301 to perform a BFD operation while SCG 303 is in a deactivated state.

In Step 313, in the case that MCG 302 configures UE 301 to perform a BFD operation, UE 301 performs the BFD operation for each TRP associated with SCG 303 (e.g., each TRP in a PSCell or a SCell of SCG 303) while SCG 303 is deactivated.

In Step 314, if UE 301 detects beam failure(s) for one TRP associated with SCG 303, UE 301 is triggered to report beam failure information to MCG 302 (or SCG 303).
(1) For example, if two TRPs in total are configured in the PSCell of SCG 303, UE 301 may a detect beam failure for one TRP within these two TRPs. Once UE 301 detects the beam failure for the TRP, UE 301 is triggered to report beam failure information to MCG 302 (or SCG 303).
(2) In an embodiment, the reported beam failure information may include at least one of:
   1) index information of the one or more TRPs;
   2) a beam failure detection (BFD) reference signal (RS) set identity (ID) of the one or more TRPs;
   3) a cell index for a primary cell of a second cell group (PSCell) of the SCG;
   4) a cell index for a secondary cell (SCell) of the SCG;
   5) a candidate RS ID for a failed TRP within the one or more TRPs; or
   6) an indication indicating whether one or more candidate beams for the one or more TRPs are found.

After Step 314, there may be following two options in different embodiments, i.e., Option 1 and Option 2.
(1) In Option 1, only Step 316 is performed after Step 314. In Step 316, after MCG 302 receives the beam failure information, MCG 302 may reconfigure a beam or a TRP to UE 301. MCG 302 transmits “configurations for reconfiguring a beam or a TRP associated with SCG 303” to UE 301.
(2) In Option 2, Steps 315A, 316A, and 316 are performed after Step 314.
   1) In Step 315A, after MCG 302 receives the beam failure information from UE 301, MCG 302 transfers the beam failure information to SCG 303.
   2) In Step 316A, SCG 303 transmits “configurations for reconfiguring a beam or a TRP associated with SCG 303” to MCG 302, and then MCG 302 transfers the reconfigure information to UE 301.
   3) In Step 316, after MCG 302 receives the beam failure information, MCG 302 may reconfigure a beam or a TRP to UE 301. MCG 302 transmits “configurations for reconfiguring a beam or a TRP associated with SCG 303” to UE 301.

FIG. 4 illustrates an exemplary flowchart of performing a RACH procedure in accordance with some embodiments of the present application. Details described in all other embodiments of the present disclosure are applicable for the embodiments shown in FIG. 4. Referring to FIG. 4, UE 401 may function as UE 101 as shown in FIG. 1. MCG 402 and SCG 403 may correspond to MN 403 and SN 403 as shown in FIG. 1, respectively. In particular, exemplary procedure 400 includes following steps.

In Step 411, UE 401 accesses a BS. MCG 402 and SCG 403 are configured to UE 401.
(1) For instance, measurement configuration(s) may be configured to UE 401 via MCG 402 and SCG 403.
(2) Configuration for a TRP (e.g., TRP #1) may be configured to UE 301 by MCG 302 or by SCG 303 via MCG 302.
(3) A BFD Set for Second TRP is configured. BFD Set for Second TRP includes Beam failure Detection Resource set for the UE for mTRP BFD operation. TRP can be described as BFD-RS set. For example, TRP #1 is BFD-RS set #1.
(4) A BFD Set for a further TRP (e.g., TRP #2) may be configured to UE 301 by MCG 302 or by SCG 303 via MCG 302. BFD Set for the further TRP includes BFD resource set for UE 301 for mTRP BFD operation. The further TRP can be described as a BFD-RS set. For instance, the number of a BFD-RS set is the number of the corresponding TRP, e.g., TRP #2 is BFD-RS set #2.
(5) For example, one or more other TRPs (e.g., TRP #3 and etc.) may be configured to UE 301 by MCG 302 or by SCG 303 via MCG 302. Likewise, each of the one or more other TRPs can be described as a BFD-RS set. For example, TRP #3 is BFD-RS set #3.
(6) For instance, a RRC message may configure multiple RA resource sets of RACH procedure for different purposes:
   1) A set of RACH Preambles and/or PRACH occasions for a beam failure recovery request.
   2) A set of RACH Preambles and/or PRACH occasions for reconfiguration with synchronization.

In Step 412, UE 401 receives, from MCG 402, RRC reconfiguration message indicating to deactivate SCG 403.
(1) For instance, the RRC Reconfiguration message includes the scg-State IE. The scg-State IE is set to deactivated.
(2) For instance, MCG 402 may configure UE 401 to perform a BFD operation while SCG 403 is deactivated.
(3) For instance, MCG 402 may configure UE 401 to perform radio link monitoring (RLM) operation while SCG 403 is deactivated. If MCG 402 configures UE 401 not to perform a RLM operation, UE 401 may perform at least one of:
   a) Stopping a physical layer problem timer (e.g., T310).
   b) Stopping timer for initiating failure recovery based on triggering a measurement report (e.g., T312).
   c) Resetting a counter for consecutive out-of-synchronization indication (e.g., N310 counter). N310 is a maximum number of consecutive “out-of-sync” indications for the SpCell received from lower layers.
   d) Resetting a counter for consecutive in-synchronization indication (e.g., N311 counter). N311 is a maximum number of consecutive “in-sync” indications for the SpCell received from lower layers.

In Step 413, UE 401 performs a BFD operation and/or a RLM operation for each PSCell of while SCG 403 is deactivated.

In Step 414, UE 401 receives a SCG activation indication (which may also be named as a SCG activation command or the like) to activate SCG 403.
(1) The SCG activation indication could be included in a RRC reconfiguration message or a MAC CE.
(2) When UE 401 receives the SCG activation indication, at least one of following may happen: TAT associated with a primary time advance group (PTAG) is not running; or a RLF associated with SCG 403 happens; or a beam failure associated with SCG 403 is detected.

In Step 414, there may be following two cases in different embodiments, i.e., Case A and Case B.
(1) In Case A, when UE 401 receives the SCG activation indication and the beam failure associated with SCG 403 is detected, UE 401 performs a RACH procedure using a RA resource set for BFR.
(2) In Case B, the beam failure associated with SCG 403 is detected before SCG activation (TAT is not running or a RLF associated with SCG 403 happens). In Case B, there may be following four options in different embodiments, i.e., Option 1 to Option 4.
   Option 1: If the beam failure associated with SCG 403 is detected when receiving the SCG activation indication, a RA resource set for BFR will be used even if TAT for PTAG is not running or a RLF associated with SCG 403 is declared.
   Option 2: The latest configured RA resource set can be used in priority, if UE 401 receives two or more of RA resource sets from MCG 402.
   Option 3: If a dedicated RA resource set is included in a RRC reconfiguration message including the SCG activation indication, this dedicated RA resource set can be used for SCG activation.
   Option 4: MCG 402 will indicate which RA set can be used for SCG activation. One indication may be added in the RRC reconfiguration message including the SCG activation indication.

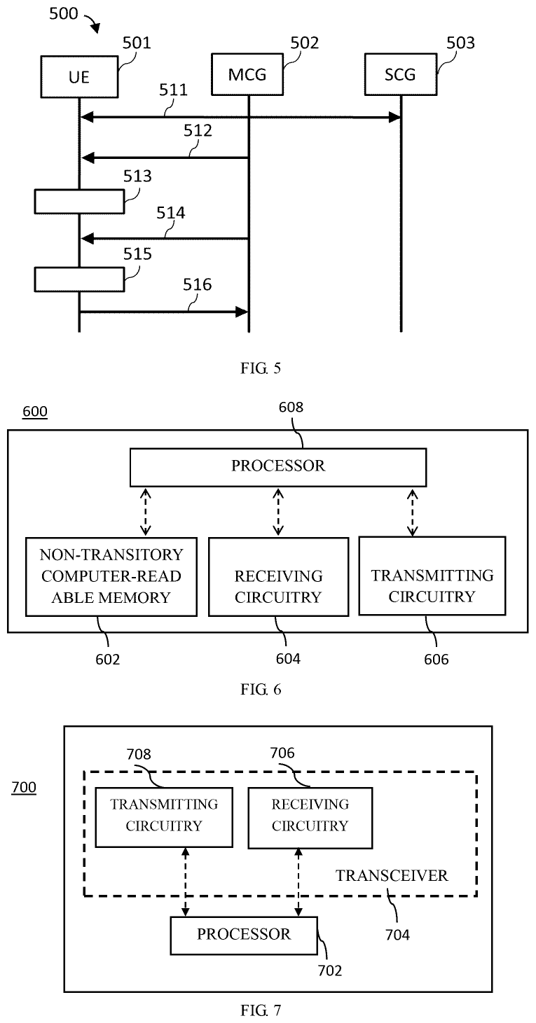

FIG. 5 illustrates an exemplary flowchart of a SCG failure information procedure in accordance with some embodiments of the present application. Details described in all other embodiments of the present disclosure are applicable for the embodiments shown in FIG. 5. Referring to FIG. 5, UE 501 may function as UE 101 as shown in FIG. 1. MCG 502 and SCG 503 may correspond to MN 503 and SN 503 as shown in FIG. 1, respectively. In particular, exemplary procedure 500 includes following steps.

In Step 511, UE 501 accesses a BS. MCG 502 and SCG 503 are configured to UE 501.
(1) For instance, measurement configuration(s) may be configured to UE 401 via MCG 402 and SCG 403.
(2) Configuration for a TRP (e.g., TRP #1) may be configured to UE 301 by MCG 302 or by SCG 303 via MCG 302.
(3) A BFD Set for Second TRP is configured. BFD Set for Second TRP includes Beam failure Detection Resource set for the UE for mTRP BFD operation. TRP can be described as BFD-RS set. For example, TRP #1 is BFD-RS set #1.
(4) A BFD Set for a further TRP (e.g., TRP #2) may be configured to UE 301 by MCG 302 or by SCG 303 via MCG 302. BFD Set for the further TRP includes BFD resource set for UE 301 for mTRP BFD operation. The further TRP can be described as a BFD-RS set. For instance, the number of a BFD-RS set is the number of the corresponding TRP, e.g., TRP #2 is BFD-RS set #2.
(5) For example, one or more other TRPs (e.g., TRP #3 and etc.) may be configured to UE 301 by MCG 302 or by SCG 303 via MCG 302. Likewise, each of the one or more other TRPs can be described as a BFD-RS set. For example, TRP #3 is BFD-RS set #3.
(6) For instance, a RRC message may configure multiple RA resource sets of RACH procedure for different purposes:
   1) A set of RACH Preambles and/or PRACH occasions for a beam failure recovery request.
   2) A set of RACH Preambles and/or PRACH occasions for reconfiguration with synchronization.

In Step 512, UE 501 receives, from MCG 502, a RRC reconfiguration message indicating to deactivate SCG 503.
(1) For instance, the RRC Reconfiguration message includes the scg-State IE. The scg-State IE is set to deactivated.
(2) For instance, MCG 502 may configure UE 501 to perform a BFD operation while SCG 503 is deactivated.
(3) For instance, MCG 502 may configure UE 501 to perform radio link monitoring (RLM) operation while SCG 503 is deactivated. If MCG 502 configures UE 501 not to perform a RLM operation, UE 501 may perform at least one of:
   a) Stopping a physical layer problem timer (e.g., T310).
   b) Stopping timer for initiating failure recovery based on triggering a measurement report (e.g., T312).
   c) Resetting a counter for consecutive out-of-synchronization indication (e.g., N310 counter). N310 is a maximum number of consecutive “out-of-sync” indications for the SpCell received from lower layers.
   d) Resetting a counter for consecutive in-synchronization indication (e.g., N311 counter). N311 is a maximum number of consecutive “in-sync” indications for the SpCell received from lower layers.

In Step 513, UE 501 performs a BFD operation and/or a RLM operation for each PSCell of while SCG 503 is deactivated.

In Step 514, UE 501 receives a SCG activation indication (which may also be named as a SCG activation command or the like) to activate SCG 503. The SCG activation indication could be included in a RRC reconfiguration message or a MAC CE.

In Step 515, UE 501 performs a RACH procedure after UE 501 receives the SCG activation indication.

In Step 516, once UE 501 fails to access SCG 503 after UE 501 receives the SCG activation indication, UE 501 initiates a SCG failure information procedure. Alternatively, UE 501 initiates a SCG failure information procedure upon detecting a SCG activation failure.
(1) For instance, UE 501 initiates transmission of the SCGFailureInformationNR message to provide a SCG activation failure indication. Different failure types will be set in the different use cases:
   a) If the random access procedure was initiated for SCG activation, UE 501 sets the failureType as SCG activation Failure;
   b) If the set of Random Access Preambles and/or PRACH occasions for beam failure recovery request is used for SCG activation, UE 501 sets the failure Type as beam Failure Recovery Failure;
   c) If the set of Random Access Preambles and/or PRACH occasions for reconfiguration with sync is used for SCG activation, UE 501 sets the failure Type as synchReconfigFailureSCG.
   d) Failure happens first while SCG 503 is deactivated.

The following texts describe specific Embodiment 3, which refers to a MR-DC case, in which a UE may transmit a request to deactivate a SCG. According to Embodiment 3, a UE and a MN may perform following operations. The UE may be UE 101 or UE1 as shown and illustrated in FIG. 1 or FIG. 2. The MN may be MN 102 as shown and illustrated in FIG. 1.

In Step 1, a UE accesses a BS. MCG and SCG are configured to the UE.
(1) For instance, measurement configuration(s) may be configured to the UE via the MCG or the SCG.
(2) The UE may receive an indication to indicate whether the UE can transmit a request to deactivate the SCG.
(3) In an embodiment, one condition may be configured to the UE. Once the condition is fulfilled, the UE can transmit a request to deactivate the SCG (e.g., a preference indication to deactivate the SCG) to the MCG. For example, the condition could be that no uplink (UL) data is transmitted to the SCG during a time duration.
(4) In an embodiment, the request to deactivate the SCG is transferred by the MCG to the SCG.

In Step 2, the UE receives, from the MCG, a RRC reconfiguration message indicating to deactivate the SCG.
(1) In an embodiment, the RRC reconfiguration message includes SCG-State information element (IE). The SCG-State IE is set to deactivated.
(2) In an embodiment, the MCG may configure the UE to perform a BFD operation while the SCG is deactivated.
(3) In an embodiment, the MCG may configure the UE to perform a RLM operation while the SCG is deactivated.

Some embodiments of the present application also provide a wireless communication apparatus for a MR-DC case. For example, FIG. 6 illustrates an exemplary block diagram of an apparatus 600 for a MR-DC case according to some embodiments of the present application.

As shown in FIG. 6, the apparatus 600 may include at least one non-transitory computer-readable medium 602, at least one receiving circuitry 604, at least one transmitting circuitry 606, and at least one processor 608 coupled to the non-transitory computer-readable medium 602, the receiving circuitry 604 and the transmitting circuitry 606. The at least one processor 608 may be a CPU, a DSP, a microprocessor etc. The apparatus 600 may be a network apparatus (e.g., a MN or a SN) or a UE configured to perform a method illustrated in the above or the like.

Although in this figure, elements such as the at least one processor 608, receiving circuitry 604, and transmitting circuitry 606 are described in the singular, the plural is contemplated unless a limitation to the singular is explicitly stated. In some embodiments of the present application, the receiving circuitry 604 and the transmitting circuitry 606 can be combined into a single device, such as a transceiver. In certain embodiments of the present application, the apparatus 600 may further include an input device, a memory, and/or other components.

In some embodiments of the present application, the non-transitory computer-readable medium 602 may have stored thereon computer-executable instructions to cause a processor to implement the methods with respect to a remote UE, a relay UE, or a network apparatus (e.g., a MN or a SN) as described or illustrated above in any of FIGS. 3-5. For example, the computer-executable instructions, when executed, cause the processor 608 interacting with receiving circuitry 604 and transmitting circuitry 606, so as to perform the steps with respect to a remote UE, a relay UE, or a network apparatus (e.g., a MN or a SN) as described or illustrated above in any of FIGS. 3-5.

FIG. 7 illustrates a further exemplary block diagram of an apparatus 700 for a MR-DC case according to some embodiments of the present application.

Referring to FIG. 7, the apparatus 700, for example a BS or a UE, may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some other embodiments of the present application, when the apparatus 700 is a UE, the processor 702 may be configured: to receive a first configuration associated with a set of transmission reception points (TRPs) for a secondary cell group (SCG) of a network; to receive a second configuration associated with a state of the SCG of the network, wherein the state of the SCG corresponds to a deactivated state; to receive an activation indication associated with the SCG from the network; and to access to the SCG via a random access channel (RACH) procedure.

According to some embodiments of the present application, when the apparatus 700 is a MN, the processor 702 is configured: to transmit a first configuration associated with a set of transmission reception points (TRPs) for a secondary cell group (SCG) to a user equipment (UE); to transmit a second configuration associated with a state of the SCG to the UE, wherein the state of the SCG corresponds to a deactivated state; to transmit an activation indication associated with the SCG to the UE; and to receive first information from the UE via a radio resource control (RRC) message, wherein the first information is associated with a beam failure associated with the SCG.

According to some embodiments of the present application, when the apparatus 700 is a SN, the processor 702 is configured to receive first information from a master cell group (MCG) via a radio resource control (RRC) message, wherein the first information is associated with a beam failure associated with a secondary cell group (SCG), wherein a state of the SCG corresponds to a deactivated state, and wherein the first information is received by the MCG from a user equipment (UE).

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”.

1. A user equipment (UE) for wireless communication, comprising:
at least one memory; and
at least one processor coupled with the at least one memory and configured to cause the UE to:
receive a first configuration associated with a state of a secondary cell group (SCG) from a network, wherein the state of the SCG corresponds to a deactivated state;
receive an activation indication associated with the SCG from the network; and
access the SCG via a random access channel (RACH) procedure.

2. The UE of claim 1, wherein the at least one processor is further configured to cause the UE to access the SCG via the RACH procedure in response to at least one of: an expiry of a time alignment timer (TAT), declaring a radio link failure (RLF) associated with the SCG, or detecting a beam failure associated with the SCG.

3. The UE of claim 1, wherein the at least one processor of the UE-is further configured to cause the UE to:
receive an indication indicating the UE not to perform a radio link monitoring (RLM) operation on the SCG while the state of the SCG corresponds to the deactivated state; and
in response to receiving the indication, to perform at least one of:
stopping a physical layer problem timer;
stopping a timer for initiating failure recovery based on triggering a measurement report;
resetting a counter for consecutive out-of-synchronization indication; or
resetting a counter for consecutive in-synchronization indication.

4. The UE of claim 1, wherein the at least one processor is further configured to cause the UE to:
receive a second configuration associated with a set of transmission reception points (TRPs) for the SCG of the network;
perform a beam failure detection operation while the state of the SCG corresponds to the deactivated state; and
in response to detecting a beam failure on one or more TRPs within the set of TRPs, transmit first information to the network via a radio resource control (RRC) message, wherein the first information includes at least one of:
index information of the one or more TRPs;
a beam failure detection (BFD) reference signal (RS) set identity (ID) of the one or more TRPs;
a cell index for a primary cell of a second cell group (PSCell) of the SCG;
a cell index for a secondary cell (SCell) of the SCG;
a candidate RS ID for a failed TRP within the one or more TRPs; or
an indication indicating whether one or more candidate beams for the one or more TRPs are found.

5. The UE of claim 1, wherein the at least one processor is further configured to cause the UE to:
perform a beam failure detection operation while the state of the SCG corresponds to the deactivated state; and
in response to detecting a beam failure on a primary cell of a second cell group (PSCell) of the SCG, transmit second information to the network via a radio resource control (RRC) message, wherein the second information includes at least one of:
a cell index for a primary cell of the PSCell;
a cell index for a secondary cell (SCell) of the SCG;
a candidate RS ID for a failed TRP within the PSCell;
an indication indicating whether one or more candidate beams for a transmission reception point (TRP) are found;
index information of a first failed TRP in two or more TRPs within the PSCell, in response to detecting beam failures on the two or more TRPs;
a BFD RS set ID of the first failed TRP, in response to detecting the beam failures on the two or more TRPs; or
a time gap between BFD operations of two TRPs within the PSCell, in response to detecting beam failures on the two TRPs.

6. The UE of claim 4, wherein the network comprises a master cell group (MCG), and wherein, in response to transmitting the first information the first information is transferred by the MCG to the SCG.

7. The UE of claim 4, wherein the RRC message is a SCG failure information message.

8. The UE of claim 1, wherein, the at least one processor is further configured to cause the UE to access the SCG by performing the RACH procedure using a random access (RA) resource set for beam failure recovery (BFR), in response to:
receiving the activation indication associated with the SCG; and
detecting a beam failure associated with the SCG.

9. The UE of claim 1, wherein, the at least one processor is further configured to cause the UE to access the SCG by performing the RACH procedure using a random access (RA) resource set for beam failure recovery (BFR), in response to detecting a beam failure associated with the SCG and in response to at least one of a time alignment timer (TAT) not being running and declaring a radio link failure (RLF) associated with the SCG.

10. The UE of claim 1, wherein the at least one processor is further configured to cause the UE to: receive a message including both a random access (RA) resource set and the activation indication associated with the SCG, and access the SCG via the RACH procedure using the RA resource set in the message.

11. The UE of claim 1, wherein the at least one processor is further configured to cause the UE to: receive an indication indicating which random access (RA) resource set is used for the RACH procedure, and access the SCG via the RACH procedure using a RA resource set indicated by the indication.

12. The UE of claim 1, wherein the at least one processor is further configured to cause the UE to:
initiate a SCG failure information procedure, in response to failing to access the SCG or in response to detecting a SCG activation failure associated with the SCG; and
transmit a message including a failure type to the network.

13. The UE of claim 12, wherein the failure type is set as at least one of:
a SCG activation failure;
a radio link failure (RLF);
a beam failure recovery failure, in response to initiating the RACH procedure for beam failure recovery (BFR) or in response to using a random access (RA) resource set for BFR for activating the SCG;
a SCG synchronization reconfiguration failure; or
a type related to a firstly occurred failure within two or more failures, in response to detecting the two or more failures during activating the SCG.

14. A master node (MN) for wireless communication, comprising:
at least one memory; and
at least one processor coupled with the at least one memory and configured to cause the MN to:
transmit a first configuration associated with a state of a secondary cell group (SCG) to a user equipment (UE), wherein the state of the SCG corresponds to a deactivated state;
transmit an activation indication associated with the SCG to the UE; and
receive first information from the UE via a radio resource control (RRC) message, wherein the first information is associated with a beam failure associated with the SCG.

15. A secondary node (SN) for wireless communication, comprising:
at least one memory; and
at least one processor coupled with the at least one memory and configured to cause the UE to:
receive first information from a master cell group (MCG) via a radio resource control (RRC) message, wherein the first information is associated with a beam failure associated with a secondary cell group (SCG),
wherein a state of the SCG corresponds to a deactivated state, and
wherein the first information is received by the MCG from a user equipment (UE).

16. A processor for wireless communication, comprising:
at least one controller coupled with at least one memory and configured to cause the processor to:
receive a first configuration associated with a state of a secondary cell group (SCG) from a network, wherein the state of the SCG corresponds to a deactivated state;
receive an activation indication associated with the SCG from the network; and
access the SCG via a random access channel (RACH) procedure.

17. The processor of claim 16, wherein the at least one controller is further configured to cause the processor to access the SCG via the RACH procedure in response to at least one of: an expiry of a time alignment timer (TAT), declaring a radio link failure (RLF) associated with the SCG, or detecting a beam failure associated with the SCG.

18. The processor of claim 16, wherein, the at least one controller is further configured to cause the processor to access the SCG by performing the RACH procedure using a random access (RA) resource set for beam failure recovery (BFR), in response to:
receiving the activation indication associated with the SCG; and
detecting a beam failure associated with the SCG.

19. The processor of claim 16, wherein, the at least one controller is further configured to cause the processor to access the SCG by performing the RACH procedure using a random access (RA) resource set for beam failure recovery (BFR), in response to detecting a beam failure associated with the SCG and in response to at least one of a time alignment timer (TAT) not being running and declaring a radio link failure (RLF) associated with the SCG.

20. The processor of claim 16, wherein the at least one controller is further configured to cause the processor to:
initiate a SCG failure information procedure, in response to failing to access the SCG or in response to detecting a SCG activation failure associated with the SCG; and
transmit a message including a failure type to the network.
